(19) United States
(12) Patent Application Publication
(10) Pub. No.: US 2011/0311729 A1
(43) Pub. Date: Dec. 22, 2011

(54) METHOD FOR MAKING SURFACE-ENHANCED RAMAN SCATTERING SUBSTRATE

(75) Inventors: YING-HUI SUN, Beijing (CN); KAI LIU, Beijing (CN); KAI-LI JIANG, Beijing (CN); SHOU-SHAN FAN, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/959,611

(22) Filed: Dec. 3, 2010

(30) Foreign Application Priority Data
Jun. 18, 2010 (CN) 201010202886.X

(51) Int. Cl. B05D 1/18; B05D 1/36; B05D 3/00

(52) U.S. Cl. 427/383.3; 427/443.1; 427/404

(57) ABSTRACT

A method for making a surface-enhanced Raman scattering (SERS) substrate is introduced. The method includes the following steps. A carbon nanotube film structure and a first solution comprising a number of metallic ions are provided. The carbon nanotube film structure includes a number of carbon nanotubes. Standard electrode potentials of the metallic ions are greater than Fermi energies of the carbon nanotubes. At least part of the carbon nanotube film structure is dipped into the first solution.

### CROSS-REFERENCE TO RELATED APPLICATION

This application claims all benefits accruing under 35 U.S.C. §119 from China Patent Application No. 201010202886.X, filed on Jun. 18, 2010, in the China Intellectual Property Office, disclosure of which is incorporated herein by reference.

### BACKGROUND

1. Technical Field

The present disclosure relates to methods for making SERS (surface-enhanced Raman scattering) substrates, particularly, a method for making an SERS substrate based on carbon nanotubes.

2. Description of Related Art

Fabrication of a stable SERS substrate with high enhancement has been a focus because it is a precondition for realizing sensitive detection. A typical SERS substrate is usually constructed by forming a plurality of metallic particles on a planar surface. However, the planar SERS substrate has limited surface area, thus cannot adsorb a lot of molecules contributed to the Raman signal. Further, it is hard to form a plurality of metallic particles having small size and defining a plurality of interparticle gaps with a small size on the planar surface, because the metallic particles easily agglomerate when applied to the planar surface.

What is needed, therefore, is to provide a method for making a SERS substrate with huge surface area and having high enhancement capability.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of making a surface-enhanced Raman scattering (SERS) substrate.

FIG. 2 is a schematic structural view of one embodiment of an SERS substrate.

FIG. 3 shows a Scanning Electron Microscope (SEM) image of a flocculated carbon nanotube film.

FIG. 4 shows an SEM image of a pressed carbon nanotube film.

FIG. 5 shows an SEM image of a drawn carbon nanotube film.

FIG. 6 shows an SEM image of a carbon nanotube film structure consisting of a plurality of stacked drawn carbon nanotube films defined as a CNT grid.

FIG. 7 shows a low magnification Transmission Electron Microscope (TEM) image of an SERS substrate defined as an Ag-CNT grid.

FIG. 8 shows a high magnification TEM image of the SERS substrate in FIG. 7.

FIG. 9 shows a comparison of Raman spectra of aqueous pyridine on the CNT grid and the Ag-CNT grid

FIG. 10 shows comparison of Raman spectra of R6G on the CNT grid and the Ag-CNT grid.

FIG. 11 is a schematic structural view of one embodiment of an SERS substrate.

FIG. 12 shows a magnification schematic structural view of part of the SERS substrate in FIG. 11.

FIG. 13 shows a comparison of Raman spectra of R6G on an MWCNT array and an Ag-MWCNT array.

FIG. 14 shows a comparison of Raman spectra of R6G on an SWCNT array and two Ag-SWCNT arrays with different thicknesses of silver film.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

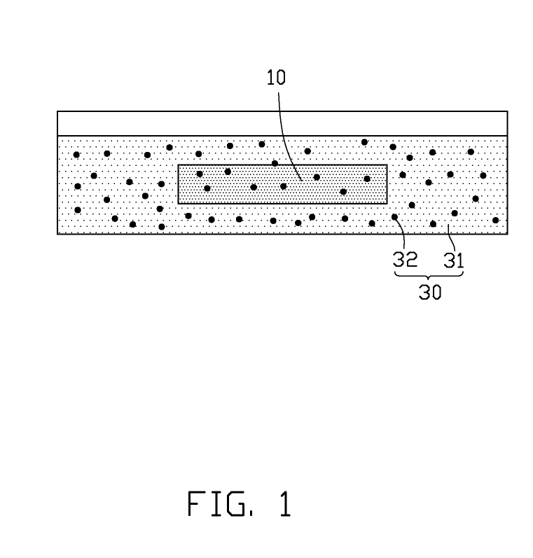

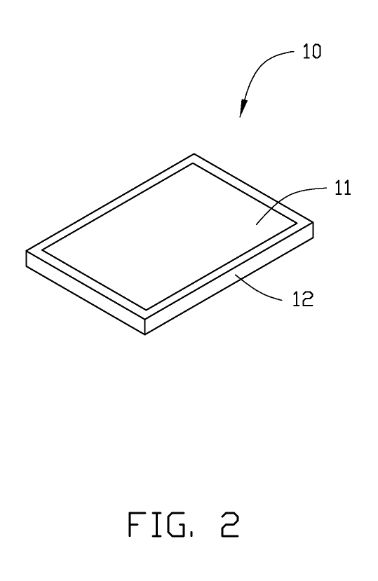

A method for making a surface-enhanced Raman scattering (SERS) substrate 10, as shown in FIG. 1 and FIG. 2, of one embodiment can include the following steps:
S10, providing a carbon nanotube film structure 11 and a first solution 30 comprising a plurality of metallic ions 31, the carbon nanotube film structure 11 comprising a plurality of carbon nanotubes joined by van der Waals attractive force therebetween. Wherein the standard electrode potentials of the metallic ions 31 being greater than Fermi energies of the carbon nanotubes; and
S20, dipping the carbon nanotube film structure 11 into the first solution.

In step S10, the carbon nanotube film structure 11 can be supported or fixed by a supporting element 12. The supporting element 12 can be a transparent substrate such as a glass panel, a plastic substrate, or a framing element such as a grid framework. If the supporting element 12 is a transparent substrate, the carbon nanotube film structure 11 can be located on a surface of the transparent substrate directly. If the supporting element 12 is a framing element, the carbon nanotube film structure 11 can be suspended on the framing element. The area of the suspended part of the carbon nanotube film structure 11 can be greater than 6 square centimeters.

The carbon nanotube film structure 11 is capable of forming a free-standing structure. The term “free-standing structure” can be defined as a structure that does not have to be supported by a substrate. For example, a free-standing structure can sustain the weight of itself when it is hoisted by a portion thereof without any significant damage to its structural integrity. The free-standing structure of the carbon nanotube film structure 11 is realized by the carbon nanotubes joined by van der Waals attractive force. So, if the carbon nanotube film structure 11 is placed between two separate supporters, a portion of the carbon nanotube film structure 11, not in contact with the two supporters, would be suspended between the two supporters and yet maintain film structural integrity. Simultaneously, the supporting element 12 is an optional structure and can be omitted, if the carbon nanotube film structure 11 is a free-standing structure.

The carbon nanotube film structure 11 includes a plurality of carbon nanotubes uniformly distributed therein, and joined by van der Waals attractive force therebetween. The carbon nanotubes in the carbon nanotube film structure 11 can be orderly or disorderly arranged. The term ‘disordered carbon nanotube film structure’ includes, but is not limited to, a structure where the carbon nanotubes are arranged along many different directions, such that the number of carbon nanotubes arranged along each different direction can be almost the same (e.g. uniformly disordered), and/or entangled with each other. ‘Ordered carbon nanotube film structure’ includes, but is not limited to, a structure where the carbon nanotubes are arranged in a consistently systematic manner, e.g., the carbon nanotubes are arranged approximately along a same direction and or have two or more sections within each of which the carbon nanotubes are arranged approximately along a same direction (different sections can have different directions). The carbon nanotubes in the carbon nanotube film structure 11 can be single-walled, double-walled, and/or multi-walled carbon nanotubes.

Macroscopically, the carbon nanotube film structure 11 may have a substantially planar structure. The planar carbon nanotube structure can have a thickness of about 0.5 nanometers to about 100 microns. Microscopically, The carbon nanotube film structure 11 includes a plurality of carbon nanotubes and defines a plurality of micropores having a size of about 1 nanometer to about 500 nanometers. Therefore, the carbon nanotube film structure 11 has a nanoporous microstructure. The carbon nanotube film structure 11 includes at least one carbon nanotube film, the at least one carbon nanotube film including a plurality of carbon nanotubes substantially parallel to a surface of the corresponding carbon nanotube film.

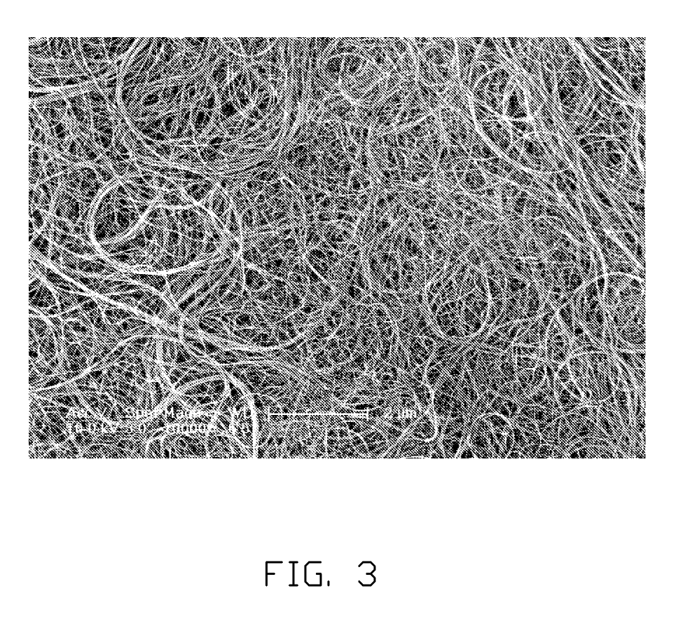

The carbon nanotube film structure 11 can include a flocculated carbon nanotube film as shown in FIG. 3. The flocculated carbon nanotube film can include a plurality of long, curved, disordered carbon nanotubes entangled with each other and can form a free-standing structure. Further, the flocculated carbon nanotube film can be isotropic. The carbon nanotubes can be substantially uniformly dispersed in the carbon nanotube film. The adjacent carbon nanotubes are acted upon by the van der Waals attractive force therebetween, thereby forming an entangled structure with micropores defined therein. Alternatively, the flocculated carbon nanotube film is very porous. Sizes of the micropores can be of about 1 nanometer to about 500 nanometers. Further, due to the carbon nanotubes in the carbon nanotube structure being entangled with each other, the carbon nanotube structure employing the flocculated carbon nanotube film has excellent durability, and can be fashioned into desired shapes with a low risk to the integrity of carbon nanotube structure. The flocculated carbon nanotube film, in some embodiments, will not require the use of structural support or due to the carbon nanotubes being entangled and adhered together by van der Waals attractive force therebetween. The flocculated carbon nanotube film can have a thickness of about 0.5 nanometers to about 100 microns, and can define a plurality of micropores having a diameter of about 1 nanometer to about 500 nanometers. The micropores defined in the flocculated carbon nanotube film can increase a specific surface area of the flocculated carbon nanotube film. Thus, more metallic ions 31 can be accommodated in the flocculated carbon nanotube film.

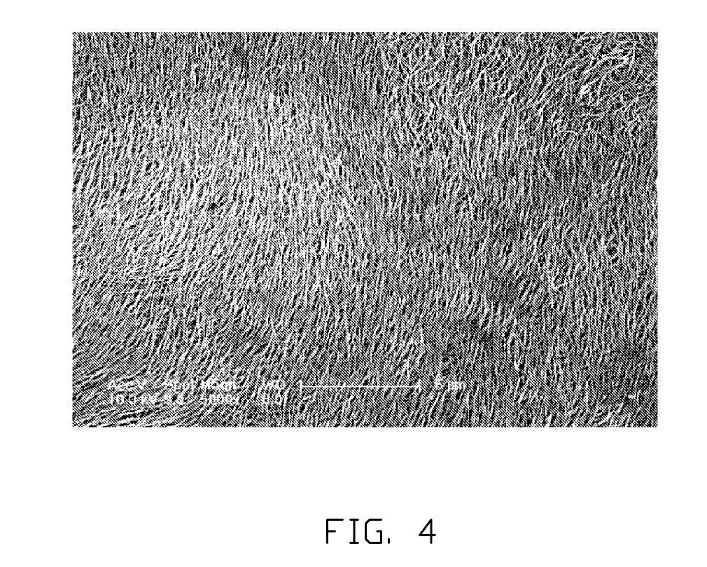

The carbon nanotube film structure 11 can include a pressed carbon nanotube film. The carbon nanotubes in the pressed carbon nanotube film can be arranged along a same direction or arranged along different directions. The carbon nanotubes in the pressed carbon nanotube film can rest upon each other. The adjacent carbon nanotubes are combined and attracted to each other by van der Waals attractive force, and can form a free-standing structure. An angle between a primary alignment direction of the carbon nanotubes and a surface of the pressed carbon nanotube film can be in an approximate range from 0 degrees to approximately 15 degrees. The pressed carbon nanotube film can be formed by pressing a carbon nanotube array. The angle is closely related to pressure applied to the carbon nanotube array. The greater the pressure, the smaller the angle. The carbon nanotubes in the carbon nanotube film can be substantially parallel to the surface of the carbon nanotube film when the angle is 0 degrees. A length and a width of the carbon nanotube film can be set as desired. The pressed carbon nanotube film can include a plurality of carbon nanotubes substantially aligned along one or more directions. The pressed carbon nanotube film can be obtained by pressing the carbon nanotube array with a pressure head. Alternatively, the shape of the pressure head and the pressing direction can determine the direction of the carbon nanotubes arranged therein. Specifically, in one embodiment, when a planar pressure head is used to press the carbon nanotube array along the direction perpendicular to a substrate. A plurality of carbon nanotubes pressed by the planar pressure head may be sloped in many directions. In another embodiment, as shown in FIG. 4, when a roller-shaped pressure head is used to press the carbon nanotube array along a certain direction, the pressed carbon nanotube film having a plurality of carbon nanotubes substantially aligned along the certain direction can be obtained. In another embodiment, when the roller-shaped pressure head is used to press the carbon nanotube array along different directions, the pressed carbon nanotube film having a plurality of carbon nanotubes substantially aligned along different directions can be obtained. The pressed carbon nanotube film can have a thickness of about 0.5 nanometers to about 100 microns, and can define a plurality of micropores having a diameter of about 1 nanometer to about 500 nanometers. The micropores defined in the pressed carbon nanotube film can increase a specific surface area of the pressed carbon nanotube film. Thus, more metallic ions 31 can be accommodated in the pressed carbon nanotube film.

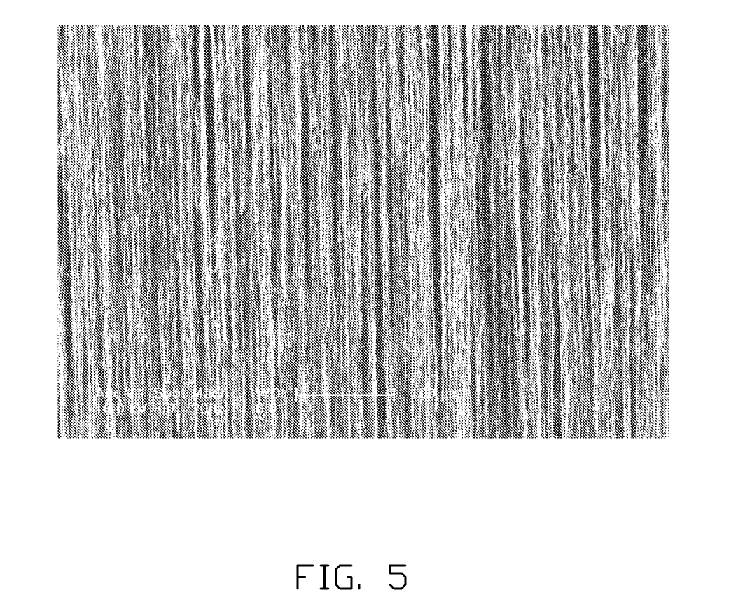

In some embodiments, the carbon nanotube film structure 11 includes at least one drawn carbon nanotube film as shown in FIG. 5. The drawn carbon nanotube film can have a thickness of about 0.5 nanometers to about 100 microns. The drawn carbon nanotube film includes a plurality of carbon nanotubes that can be arranged substantially parallel to a surface of the drawn carbon nanotube film. A plurality of micropores having a size of about 1 nanometer to about 500 nanometers can be defined by the carbon nanotubes. A large number of the carbon nanotubes in the drawn carbon nanotube film can be oriented along a preferred orientation, meaning that a large number of the carbon nanotubes in the drawn carbon nanotube film are arranged substantially along the same direction. An end of one carbon nanotube is joined to another end of an adjacent carbon nanotube arranged substantially along the same direction, by van der Waals attractive force. More specifically, the drawn carbon nanotube film includes a plurality of successively oriented carbon nanotube segments joined end-to-end by van der Waals attractive force therebetween. Each carbon nanotube segment includes a plurality of carbon nanotubes substantially parallel to each other, and joined by van der Waals attractive force therebetween. The carbon nanotube segments can vary in width, thickness, uniformity and shape. A small number of the carbon nanotubes are randomly arranged in the drawn carbon nanotube film, and has a small if not negligible effect on the larger number of the carbon nanotubes in the drawn carbon nanotube film arranged substantially along the same direction. The carbon nanotube film is capable of forming a free-standing structure. The term “free-standing structure” can be defined as a structure that does not have to be supported by a substrate. For example, a free-standing structure can sustain the weight of itself when it is hoisted by a portion thereof without any significant damage to its structural integrity. The free-standing structure of the drawn carbon nanotube film is realized by the successive segments joined end to end by van der Waals attractive force.

Understandably, some variation can occur in the orientation of the carbon nanotubes in the drawn carbon nanotube film as can be seen in FIG. 4. Microscopically, the carbon nanotubes oriented substantially along the same direction may not be perfectly aligned in a straight line, and some curve portions may exist. Furthermore, it can be understood that some carbon nanotubes are located substantially side by side and oriented along the same direction and in contact with each other.

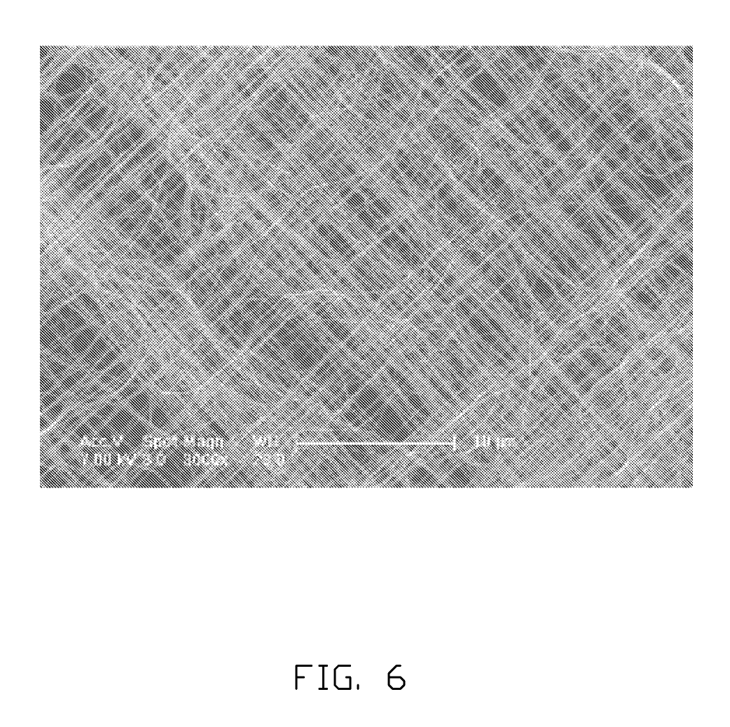

Referring to FIG. 6, in one embodiment, the carbon nanotube film structure 11 of the SERS substrate 10 consists of a plurality of stacked drawn carbon nanotube films. The number of the layers of the drawn carbon nanotube films is not limited, provided the thickness of the carbon nanotube film structure 11 can be maintained in a range from about 0.5 nanometers to about 100 microns. Adjacent drawn carbon nanotube films can be adhered by only the van der Waals attractive force therebetween. An angle can exist between the carbon nanotubes in adjacent drawn carbon nanotube films. The angle between the aligned directions of the adjacent drawn carbon nanotube films can range from 0 degrees to about 90 degrees. In one embodiment, the angle between the aligned directions of the adjacent drawn carbon nanotube films is substantially 90 degrees, thus a plurality of substantially uniform micropores is defined by the carbon nanotube film structure 11.

In step S20, the first solution 30 can cover the carbon nanotube film structure 11, or can only cover part of the carbon nanotube film structure 11. The first solution 30 including the metallic ions 31 can also include a mixture solvent 32. The mixture solvent 32 can include water and organic solvent. The water can be configured for loading the metallic ions 31. The organic solvent can be configured for soaking the carbon nanotubes. Thus, when the carbon nanotubes of the carbon nanotube film structure 11 is soaked by the mixture solvent 32, the metallic ions 31 carried by the mixture solvent 32 come into contact with the carbon nanotubes. The organic solvent can include methanol, ethanol, acetone, dimethyl sulphoxide, dimethyl sulfoxide amide, N-methyl pyrrolidone, or combinations thereof. In one embodiment, the first solution 30 includes the water and the ethanol. A volume of the water can be substantially equal to a volume of the ethanol.

The metallic ions 31 in the first solution 30 can include transition metal ions, noble metal ions, or combinations thereof. The metallic ions 31 can include pure metal ions, metal acid radical ions, or combinations thereof. The pure metal ions can be silver ions (Ag⁺), gold ions (Au³⁺), copper ions (Cu⁺), palladium ions (Pd²⁺), platinum ions (Pt²⁺), titanium ions (Ti³⁺), or combinations thereof. The pure metal ions can be formed by dissolving metallic salt in the first solution 30. The metal acid radical ions can be PtCl₄²⁻, AuCl₄⁻, CuCl₄²⁻, NiCl₄²⁻, PdCl₄²⁻, and combinations thereof. In one embodiment, the metallic ions 31 are chloroauric acid ions (AuCl₄⁻) formed by dissolving chloroauric acid in the first solution 30.

A work function of the carbon nanotube in the carbon nanotube film structure 11 is substantially equal to 5 electron-volts (eV), thus, the Fermi energy of the carbon nanotube is substantially equal to +0.5 volts (V). A standard electrode potential of the silver ions (Ag⁺) is substantially equal to 0.8 volts. A standard electrode potential of the gold ion (Au³⁺) is substantially equal to 1.5 volts. A standard electrode potential of the chloroauric acid ion (AuCl₄⁻) is substantially equal to 1.002 volts. A standard electrode potential of the copper ion (Cu⁺) is substantially equal to 0.52 volts. A standard electrode potential of the palladium ions (PtCl₄²⁻) is substantially equal to 0.775 volts. Because the standard electrode potentials of the metallic ions 31 are greater than the Fermi energies of the carbon nanotubes, a direct redox reaction between the metallic ions 31 and the carbon nanotubes can occurr, when the carbon nanotube film structure 11 is dipped in the first solution 30. Thus, the metallic ions 31 can be reduced to metallic nanoparticles by means of electroless redox reactions. In the redox reaction process, the carbon nanotube film structure 11 is capable of providing charges and receiving cavities. Thus, some carbon atoms of the carbon nanotube film structure 11 can be oxidized into oxygen-containing functional groups, such as carboxyl or hydroxyl. Oxygen in the oxygen-containing functional group can be from the water. The metallic ions 31 contacting the carbon atoms can be reduced to metal atoms, when the metal ions receive the charges provided by the carbon atoms. The metallic nanoparticles positioned on the carbon nanotube film structure 11 can be formed by the metallic atoms deposited on a surface of the carbon nanotube film structure 11. Each of the metallic nanoparticles can include a plurality of metallic atoms. For example, when the chloroauric acid ion (AuCl₄⁻) receives three charges from the carbon atoms of the carbon nanotube film structure 11, the chloroauric acid ion can be reduced to a gold atom. The reduction reaction can be conducted by the following formula: AuCl₄⁻+3e⁻=Au (solid)+4Cl⁻. A plurality of gold atoms can be deposited on a surface of the carbon nanotube film structure 11 to form gold nanoparticles. Thus, the SERS substrate 10 including the carbon nanotube film structure 11 and the metallic nanoparticles deposited on the carbon nanotube film structure 11 can be obtained.

To make the SERS substrate 10 have a high Raman enhancement factor, an average diameter of the metallic nanoparticles can be about 5 nanometers to about 50 nanometers. Generally, the longer a dipping time of the carbon nanotube film structure 11, the greater the average diameter of the metallic nanoparticles. Thus, the average diameter of the metallic nanoparticles can be controlled by the dipping time. In one embodiment, to improve the Raman enhancement factor of the SERS substrate 10, the average diameter of the metallic nanoparticles is controlled to about 7 nanometers to about 16 nanometers. Understandably, less than 1 percent of the metallic particles can have a diameter greater than 50 nanometers or less than 5 nanometers.

A plurality of interparticle gaps can be defined among the metallic nanoparticles. To make the SERS substrate 10 have a high Raman enhancement factor, an average interparticle gaps can be about 1 nanometer to about 15 nanometers. Generally, the greater the density of the carbon nanotube film structure 11, the smaller the average interparticle gaps. Thus, the density of the carbon nanotube film structure 11 can determine the average interparticle gaps. In one embodiment, to improve the Raman enhancement factor of the SERS substrate 10, the average interparticle gaps is controlled to about 1 nanometer to about 5 nanometers. Understandably, less than 1 percent of the interparticle gaps can be greater than 15 nanometers.

When the carbon nanotube film structure 11 is dipped into the first solution 30 directly, the metallic nanoparticles can be deposited on a surface of the carbon nanotube film structure 11 to fabricate the SERS substrate 10 by means of electroless redox reactions. Electrodes and electrical current can not be needed for the method for making the SERS substrate 10, thus, the method for making the SERS substrate 10 is simpler than conventional methods presently used. The carbon nanotubes of the SERS substrate 10 can have small dimensions and define a plurality of uniform micropores. Thus, the metallic particles having small size can be formed on the carbon nanotube film structure 11 to define a plurality of interparticle gaps with a small size. The smaller the size of the interparticle gap, the greater the electromagnetic enhancement and Raman enhancement factor of the SERS substrate 10.

To speed the redox reactions between the carbon nanotube film structure 11 and the metallic ions 31 in the first solution 30, a reducing agent can be introduced into the first solution 30. The reducing agent can speed the redox reactions between the carbon nanotube film structure 11 and the metallic ions 31, thus, time for redox depositions of the metallic nanoparticles can be less. The reducing agent can be hydroxy hydrochloride, acetaldehyde, formaldehyde, or glucose.

The method for making the SERS substrate 10 can further include the following step: S30, providing a second solution comprising the metallic ions 31 and dipping the carbon nanotube film structure 11 into the second solution, wherein the carbon nanotube film structure 11 includes the metallic nanoparticles deposited thereon, and a concentration of the metallic ions 31 dissolved in the first solution 30 is greater than a concentration of the metallic ions 31 dissolved in the second solution.

In step S30, ingredients in the second solution can be similar to elements in the first solution 30. The difference is that the concentration of the metallic ions 31 dissolved in the second solution is less than 2% percent of the concentration of the metallic ions 31 dissolved in the first solution 30. For example, if the concentration of the metallic ions 31 dissolved in the first solution 30 is 5 millimole per liter, for the concentration of the metallic ions 31 dissolved in the first solution 30 can be 0.05 millimole per liter.

Because of the concentration of the metallic ions 31 dissolved in the second solution is less than the concentration of the metallic ions 31 dissolved in the first solution 30, metallic ions 31 in the second solution contacting each of the carbon nanotubes can be decreased. Metallic atoms deposited on each of the carbon nanotubes can be decreased. Specific surface areas of the metallic nanoparticles located on the carbon nanotubes are greater than specific surface areas of the carbon nanotubes. When the metallic ions 31 in the second solution are reduced to metallic atoms, more metallic atoms are located on the metallic nanoparticles. Thus, the deposition of the metallic atoms can increase the diameters of the metallic nanoparticles, and with little affect on the interparticle gaps among the metallic nanoparticles.

The reducing agent can also be applied to the second solution to speed the redox reactions between the carbon nanotube film structure 11 and the metallic ions 31.

The method for making the SERS substrate 10 can further include the following steps:
S40, washing the carbon nanotube film structure 11 with the metallic nanoparticles located thereon with a mixed solution, the mixed solution comprising water and organic solvent; and
S50, drying the carbon nanotube film structure 11 washed by the mixed solution.

In step S40, the mixed solution is configured for cleaning the carbon nanotube film structure 11 to remove impurities on the carbon nanotube film structure 11. The mixed solution can include water and organic solvent. The organic solvent can be methanol, ethanol, dimethyl sulphoxide, or combinations thereof. In one embodiment, the mixed solution can include the water and the ethanol. A volume of the water can be substantially equal to a volume of the ethanol.

In step S50, the carbon nanotube film structure 11 washed by the mixed solution can be dried by means of air-dried or heating to evaporate the water in the mixed solution.

To study the enhancement of the SERS substrate 10, a plurality of silver nanoparticles are located on two stacked drawn carbon nanotube films as shown in FIG. 6. Adjacent drawn carbon nanotube films can be adhered by only the van der Waals attractive force therebetween. The angle between the aligned directions of the adjacent drawn carbon nanotube films can be substantially 90 degrees. Each of the silver nanoparticles can have a diameter from about 7 nanometers to 16 nanometers. Interparticle gaps formed among the silver particles can be about 1 nanometer to about 5 nanometers.

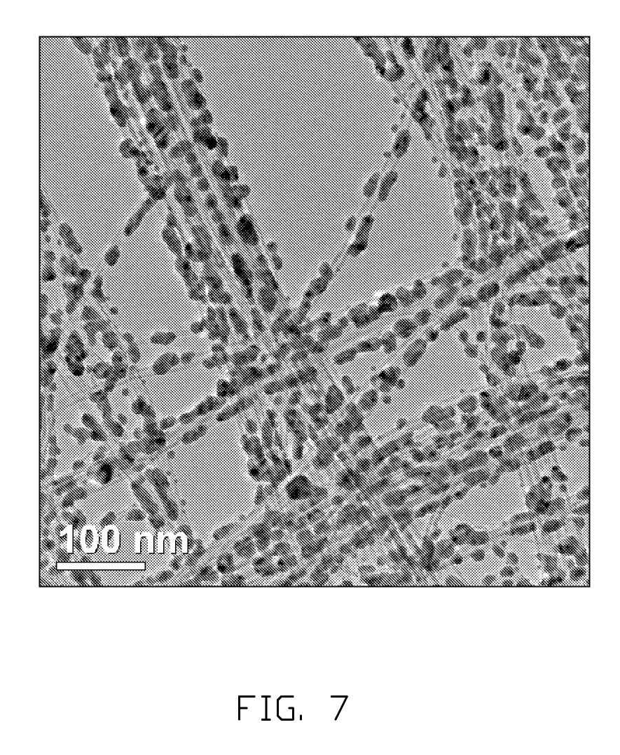

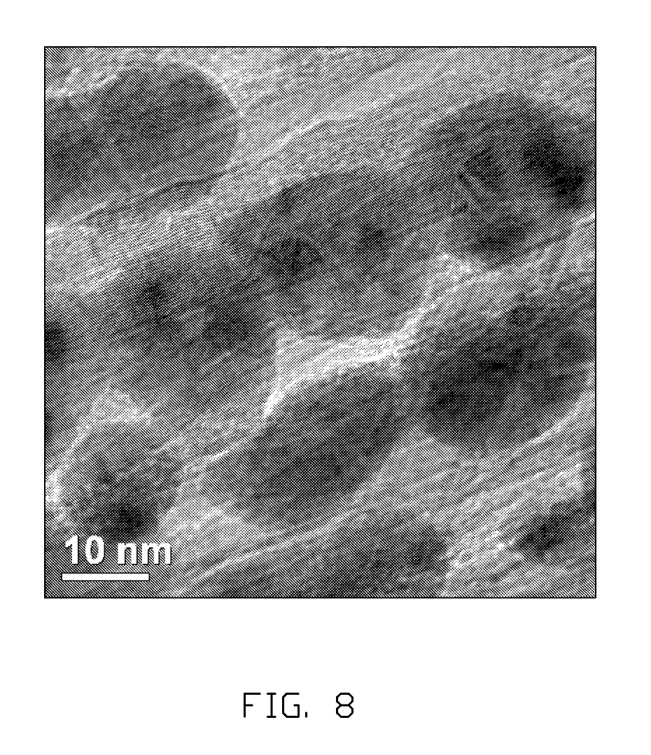

The two stacked drawn carbon nanotube films can be defined as a CNT grid. Referring to FIG. 7 and FIG. 8, the SERS substrate 10 including the CNT grid and the silver nanoparticles can be provided and be defined as an Ag-CNT grid. To test a Raman-enhancing capability of the CNT grid and the Ag-CNT grid, two organic molecules can be selected for measurement by the CNT grid and the Ag-CNT grid respectively.

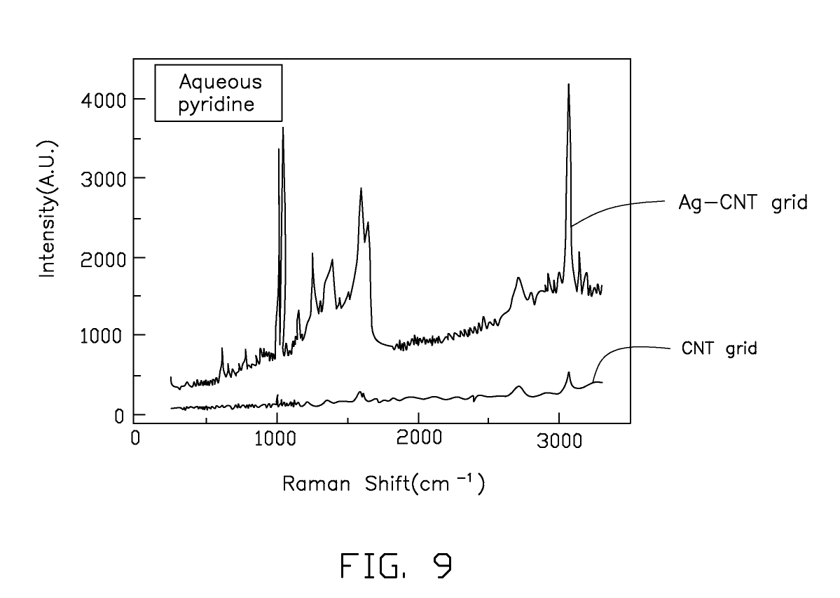

A water solution of pyridine (volume ratio of pyridine to water=1:4) can be applied to the CNT grid and the Ag-CNT grid and the Ag—SiO₂-CNT grid respectively, and then Raman spectra of the CNT grid and the SERS substrate 10 recorded. As shown in FIG. 9, Raman spectrum of pyridine on the CNT grid cannot present the details of vibration modes of pyridine except for several peaks at 657, 1002, 1034, and 3073 cm⁻¹ with very low intensity. In contrast, details and highly enhanced Raman peaks can be observed for pyridine adsorbed on the Ag-CNT grid, and can reveal the capability of the Ag-CNT grid.

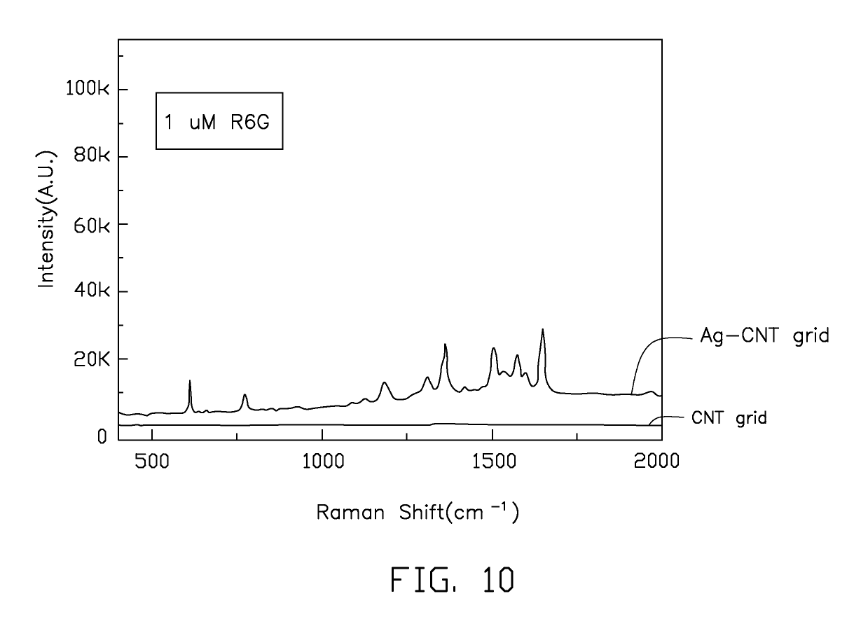

A droplet of Rhodamine 6G (R6G) ethanol solution (10⁻⁶ M) can be used to slightly soak the surfaces of the CNT grid and the Ag-CNT grid. Raman spectra of R6G on the two substrates can be recorded after the evaporation of ethanol. As shown in FIG. 10, highly enhanced Raman peaks can be observed for R6G adsorbed on the Ag-CNT grid, while Raman spectrum of R6G on the CNT grid cannot present any visible vibration modes of R6G. In normal Raman scattering, the fluorescence of R6G usually hinders the observation of its Raman signal because a cross section of Raman scattering is extremely smaller than a cross section of the fluorescence. In the Ag-CNT grid, smaller interparticle gaps formed among the silver particles can improve the electromagnetic properties of the substrate. Thus, both the cross section of the Raman scattering and the cross section of fluorescence can be increased. If the interparticle gap is small enough, the cross section of the Raman scattering can become comparable to or even larger than the cross section of the fluorescence. Therefore, obvious Raman peaks can be detected with the fluorescence spectrum. In experimental studies, a fluorescence quench of the R6G has often been observed because of a rapid energy transfer from excited electronic state to a surface of the metallic particles. In FIG. 10, the fluorescence of R6G is quenched to a low and steady state for the Ag-CNT grid. An effective method of charge transfer can be provided because of the silver film and the carbon nanotubes in Ag-CNT grid. The charge transfer can be helpful for the quenching of R6G fluorescence.

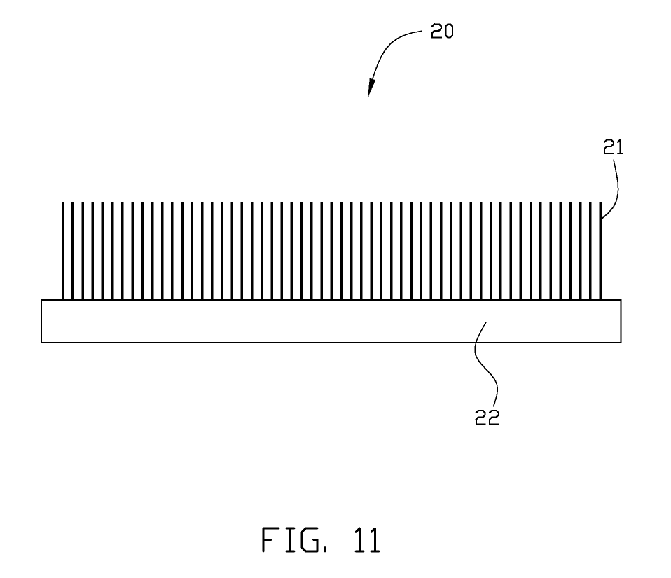

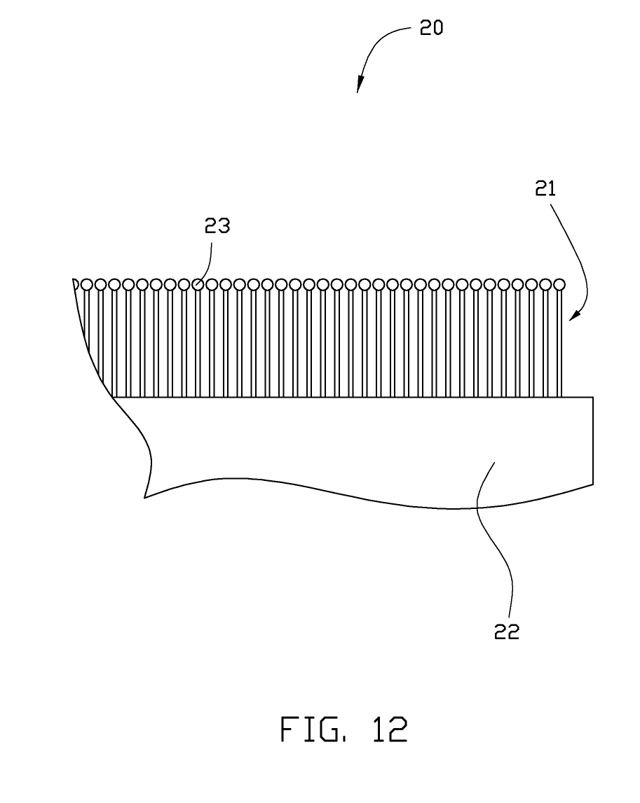

One embodiment for a method for making a surface-enhanced Raman scattering (SERS) substrate 20, as shown in FIG. 11 and FIG. 12, is similar to the method for making the surface-enhanced Raman scattering (SERS) substrate 10 as shown in FIG. 1. The difference is that carbon nanotubes of the carbon nanotube film structure 21 are substantially perpendicular to a surface of the carbon nanotube film structure 21 to form an array. Lengths of the carbon nanotubes can be substantially equal to each other. The carbon nanotubes can be joined by van der Waals attractive force therebetween.

The carbon nanotube film structure 21 is located on a surface of a transparent substrate 22. The carbon nanotubes can be substantially perpendicular to the surface of the transparent substrate 22. Part of the carbon nanotube film structure 21 can be dipped into the first solution 30. In one embodiment, a first side of the carbon nanotube film structure 21 opposite to the transparent substrate 22 is dipped into the first solution 30, thus, a metallic film is located on a surface of the carbon nanotube film structure 21 opposite to the transparent substrate 22. Microscopically, the metallic film can include a plurality of metallic particles 23. The metallic particle 23 can have a diameter of about 10 nanometers to about 50 nanometers. The metallic particles 23 can be located on distal ends of the carbon nanotubes as shown in FIG. 12.

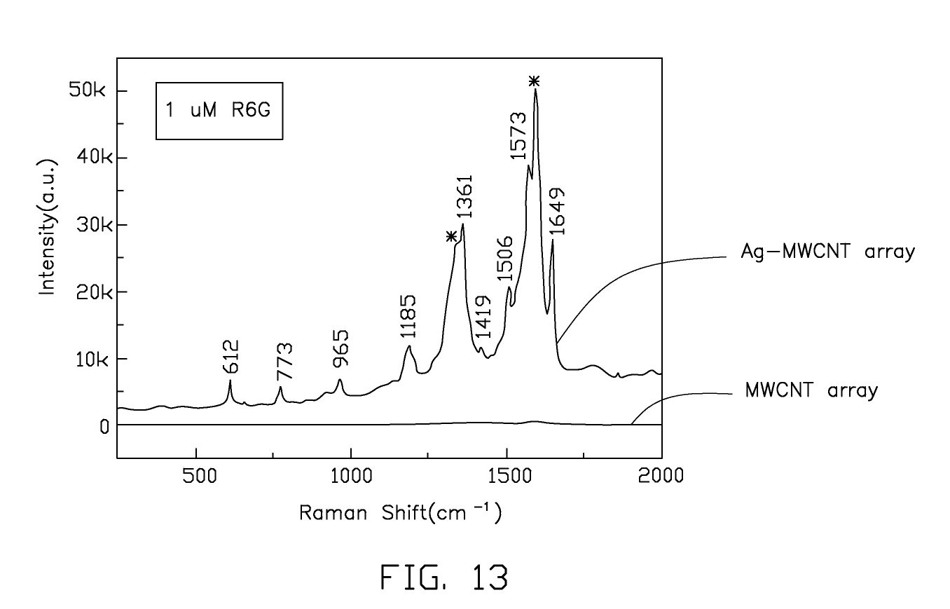

To test a Raman-enhancing capability of the SERS substrate 20 including the MWCNTs, an Ag-MWCNT array and a MWCNT array can be provided. The Ag-MWCNT array can include a carbon nanotube film structure 21 consisting of MWCNTs and a plurality of silver nanoparticles located on a surface of the carbon nanotube film structure 21. The silver nanoparticles can have an average diameter of about 13 nanometers to about 17 nanometers. The MWCNT array can include a carbon nanotube film structure consisting of MWCNTs. A droplet of R6G ethanol solution can be used to slightly soak the surfaces of the Ag-MWCNT array and the MWCNT array. As shown in FIG. 13, Raman spectrum for the MWCNT gird cannot present the details of vibration modes of Rhodamine 6G (R6G) with very low intensity. In contrast, details and highly enhanced Raman peaks can be observed for Rhodamine 6G adsorbed on the Ag-MWCNT array.

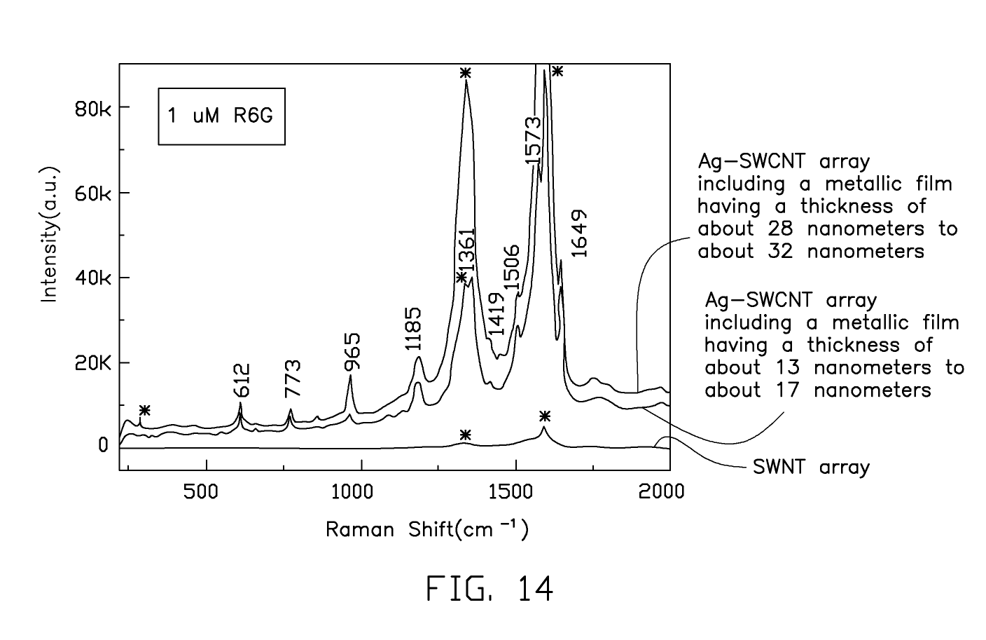

To test a Raman-enhancing capability of the SERS substrate 20 including the SWCNTs, two Ag-SWCNT arrays and an SWCNT array can be provided. Each of the two Ag-SWCNT arrays can include a carbon nanotube film structure consisting of SWCNTs and a plurality of silver nanoparticles located on a surface of the carbon nanotube film structure. The average diameter of one Ag-SWCNT array can have an average diameter of about 13 nanometers to about 17 nanometers. The average diameter of the other one of the two Ag-SWCNT arrays can have a thickness of about 28 nanometers to about 32 nanometers. The SWCNT array can include a carbon nanotube film structure 21 consisting of SWCNTs. A droplet of R6G ethanol solution can be used to slightly soak the surfaces of the two Ag-SWCNT arrays and the SWCNT array. As shown in FIG. 14, Raman spectrum for the SWCNT gird cannot present the details of vibration modes of R6G with very low intensity. In contrast, details and highly enhanced Raman peaks can be observed for R6G adsorbed on two Ag-SWCNT arrays.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

What is claimed is:

1. A method for making a surface-enhanced Raman scattering (SERS) substrate, comprising the following steps:
providing a carbon nanotube film structure and a first solution comprising a plurality of metallic ions, the carbon nanotube film structure comprising a plurality of carbon nanotubes joined by van der Waals attractive force therebetween, and standard electrode potentials of the plurality of metallic ions being greater than Fermi energies of the plurality of carbon nanotubes; and
dipping at least part of the carbon nanotube film structure into the first solution.

2. The method of claim 1, wherein the step of dipping the at least part of the carbon nanotube film structure comprises a step of inducing a direct redox reaction between the plurality of metal ions and the plurality of carbon nanotubes.

3. The method of claim 2, wherein the step of inducing the direct redox reaction comprises a step of reducing the metallic ions to metallic nanoparticles by means of electroless redox reactions, wherein the metallic nanoparticles are deposited on a surface of the at least part of the carbon nanotube film structure.

4. The method of claim 3, further comprising following steps:
washing the at least part of the carbon nanotube film structure having the metallic nanoparticles located thereon with a mixed solution, the mixed solution comprising water and organic solvent; and
drying the at least part of the carbon nanotube film structure washed by the mixed solution.

5. The method of claim 3, further comprising a step of providing a second solution comprising the metallic ions and dipping the at least part of the carbon nanotube film structure having the metallic nanoparticles into the second solution, wherein a concentration of the metallic ions dissolved in the first solution is greater than a concentration of the metallic ions dissolved in the second solution.

6. The method of claim 1, wherein the metallic ions are selected from the group consisting of transition metal ions, noble metal ions, and combinations thereof.

7. The method of claim 1, wherein the metallic ions are selected from the group consisting of pure metal ions, metal acid radical ions, and combinations thereof.

8. The method of claim 7, wherein the metal acid radical ions are selected from the group consisting of AuCl₄⁻, PtCl₄⁻, CuCl₄²⁻, NiCl₄²⁻, PdCl₄²⁻, and combinations thereof.

9. The method of claim 1, wherein the first solution further comprises water and organic solvent.

10. The method of claim 1, wherein the first solution further comprises a reducing agent.

11. The method of claim 1, wherein the carbon nanotube film structure is a free-standing structure.

12. The method of claim 1, wherein part of the carbon nanotube film structure is attached to a framing element, and another part of the carbon nanotube film structure is suspended.

13. The method of claim 1, wherein the carbon nanotubes are substantially parallel to a surface of the carbon nanotube film structure.

14. The method of claim 13, wherein the carbon nanotubes are substantially aligned in a single direction.

15. The method of claim 13, wherein the carbon nanotube film structure is located on a surface of a supporting element.

16. A method for making a surface-enhanced Raman scattering (SERS) substrate, comprising the following steps:
providing a carbon nanotube film structure and a first solution comprising a plurality of metallic ions, the carbon nanotube film structure comprising a plurality of carbon nanotubes, and standard electrode potentials of the plurality of metallic ions being greater than Fermi energies of the plurality of carbon nanotubes; and
dipping at least part of the carbon nanotube film structure into the first solution to deposit metallic nanoparticles on the carbon nanotube film structure.
